(19) United States
(12) Patent Application Publication
(10) Pub. No.: US 2022/0060056 A1
(43) Pub. Date: Feb. 24, 2022

(54) ADAPTIVE WIRELESS POWER TRANSMITTER

(71) Applicant: POWERMAT TECHNOLOGIES LTD., Petach Tikva (IL)

(72) Inventor: Itay SHERMAN, Petach Tikva (IL)

(73) Assignee: POWERMAT TECHNOLOGIES LTD., Petach Tikva (IL)

(21) Appl. No.: 17/299,408

(22) PCT Filed: Dec. 3, 2019
(86) PCT No.: PCT/IB2019/060415

§ 371 Date: Jun. 3, 2021

Related U.S. Application Data
(60) Provisional application No. 62/774,904, filed on Dec. 4, 2018.

(51) Int. Cl. H02J 50/40; H02J 50/10; H02J 50/90

(52) U.S. Cl. CPC H02J 50/402; H02J 50/90; H02J 50/10

(57) ABSTRACT

A method for wirelessly charging, by a transmitter, at least one receiver placed above at least one coil having at least one section, the method comprising: determining a plurality of charging locations that form a charging area above the at least one coil; determining a matrix of magnetic field contributions of each section in the at least one coil to each charging location of the plurality of charging locations; determining a magnetic field pattern of the charging area; calculating a current vector that comprises a current value for the each section in the at least one coil; and driving, by the transmitter, the each section in the at least one coil with the current vector for shaping the magnetic field pattern.

### CROSS-REFERENCE TO RELATED APPLICATION

This application claims priority under 35 U.S.C. § 119(e) from co-pending; U.S. Provisional Patent Application No. 62/774,904, by Itay Sherman, titled “Adaptive Wireless Power transmitter”, filed on Dec. 4, 2018, which is incorporated in its entirely by reference for all purposes.

### TECHNICAL FIELD

The present disclosed subject matter relates to wireless power charging systems. More particularly, the present disclosed subject matter relates to transmitters capable of supporting higher power receiver devices having a verity of receiver coil sizes.

### BACKGROUND

Growing demand for wireless power charging systems, led to dramatic deployments increase, in a wide variety of venues, raises the need for increasing the effective charging distance between a transmitter and a receiver.

Commercially available inductive wireless power transmitters are using single or multiple partially overlapping coils to transfer power to a receiver coil of chargeable devices. Typically, the coils are composed of multiple wire loops arranged in one or more layers that are evenly spaced. The magnetic field radiation pattern of these coils is fixed when observed from a specific Z distance above. For a round coil these include concentric pattern of magnetic field with maximum energy at the center and falling magnetic field away from the center.

Commercially available receiver coils diameter for a mobile phone are in the region of 35-50 millimeters, while for larger devices, such as laptops that also require higher power, the desired receiver coil dimeter is larger than 70 millimeters. On the other hand, smaller devices, such as smart watches, having a coil diameter smaller than 30 millimeters have to be supported as well.

A transmitter standard coil would create a fixed magnetic field pattern which cannot be simultaneously optimal for all the commercially available device, such as the devices listed above. For such standard transmitter coils, only the magnitude of the magnetic field can be controlled, but not its shape.

In addition, having the transmitter coil installed with distances, larger than a few millimeters, bellow a surface on which the receiver is placed, would cause the magnetic field pattern to be spread and expend as the receiver is move away from the center. Therefore, the magnetic field expands outside the desired area of the receiving coil into an area where foreign objects may be present.

### BRIEF SUMMARY

According to a first aspect of the present disclosed subject matter a method for wirelessly charging, by a transmitter, at least one receiver placed above at least one coil having at least one section, the method comprising: determining a plurality of charging locations that form a charging area above the at least one coil; determining a matrix of magnetic field contributions of each section in the at least one coil to each charging location of the plurality of charging locations; determining a magnetic field pattern of the charging area; calculating a current vector that comprises a current value for the each section in the at least one coil; and driving, by the transmitter, the each section in the at least one coil with the current vector for shaping the magnetic field pattern.

In some exemplary embodiments, the at least one coil is an array of coils, and wherein each coil is comprised of at least one section.

In some exemplary embodiments, a total number of the charging location in the charging area is greater than a total number of sections in the array.

In some exemplary embodiments, the matrix of magnetic field contributions is determined based on mathematical calculations using simulation tools for Maxwell equations solution.

In some exemplary embodiments, the matrix of magnetic field contributions is determined based on measuring a magnetic contribution of each charging location of the plurality of charging location that is created by a predetermined reference current flowing in turn through each section, wherein the measuring is repeated for each turn.

In some exemplary embodiments, the method comprising storing the matrix of magnetic field contributions in a memory of the transmitter.

In some exemplary embodiments, the magnetic field pattern provides an optimal magnetic field values to the at least one receiver placed on the charging area.

In some exemplary embodiments, the determining a magnetic field pattern of the charging area is repeatedly executed to dynamically update the magnetic field pattern due to changes selected from a group consisting of a movement of a receiver on the charging area; placing another receiver on the charging area; removing any receiver from the charging area; and any combination thereof.

In some exemplary embodiments, the transmitter is configured to determine a specific place of the at least one receiver placed on the charging area, and wherein the specific place define at least one charging location associated with the specific place.

In some exemplary embodiments, the magnetic field pattern of the charging area has powerful magnetic field at charging location associated with the specific place and close to zero magnetic field at the rest of the charging location.

In some exemplary embodiments, the current vector is configured to shape the magnetic field pattern of the charging area and wherein the calculating a current vector is repeated following changes of the magnetic field pattern.

In some exemplary embodiments, the calculating a current vector that comprises a current value for each section further comprises providing a magnetic field pattern with minimal error.

In some exemplary embodiments, the current vector comprises current values greater than zero for sections associated with charging location that are not associated with the specific place for reducing magnetic field pattern errors.

In some exemplary embodiments, the current vector is a precalculated current vector configured to shape a magnetic field pattern of the charging area situated above an array comprising coils selected from a group consisting of: uniform wire density coils; non-uniform wire density coils: concentric coils non-concentric coils; reverse direction; and any combination thereof.

In some exemplary embodiments, the transmitter is configured to drive the at least one coil having at least one section independently.

The method of claim 1, wherein the transmitter is configured to drive each section of the at least one coil independently.

According to a first aspect of the present disclosed subject matter a method that utilizes the transmitter of claim 1 for designing at least one coil having at least one section, the method comprising: determining a plurality of charging locations that form a charging area above the at least one coil; determining a matrix of magnetic field contributions of each section in the at least one coil to each charging location of the plurality of charging locations; determining a magnetic field pattern of the charging area; calculating a current vector that comprises a current value for the each section in the at least one coil; and designing geometrical properties of the at least one coil having at least one section according to the current vector.

In some exemplary embodiments, the geometrical properties of the at least one coil having at least one section are selected from a group consisting of: uniform wire density coils; non-uniform wire density coils; concentric coils; non-concentric coils; reverse direction coils; and any combination thereof.

In some exemplary embodiments, an outcome of the designing geometrical properties of the at least one coil having at least one section is configured to satisfy the current vector in order to enable driving the at least one coil having at least one, by a single driver of the transmitter, with only one current for shaping the magnetic field pattern.

Unless otherwise defined, all technical and scientific terms used herein have the same meaning as commonly understood by one of ordinary skill in the art to which this disclosed subject matter belongs. Although methods and materials similar or equivalent to those described herein can be used in the practice or testing of the present disclosed subject matter, suitable methods and materials are described below. In case of conflict, the specification, including definitions, will control. In addition, the materials, methods, and examples are illustrative only and not intended to be limiting.

### BRIEF DESCRIPTION OF THE DRAWINGS

Some embodiments of the disclosed subject matter described, by way of example only, with reference to the accompanying drawings. With specific reference now to the drawings in detail, it is stressed that the particulars shown are by way of example and for purposes of illustrative discussion of the preferred embodiments of the present disclosed subject matter only, and are presented in the cause of providing what is believed to be the most useful and readily understood description of the principles and conceptual aspects of the disclosed subject matter. In this regard, no attempt is made to show structural details of the disclosed subject matter in more detail than is necessary for a fundamental understanding of the disclosed subject matter, the description taken with the drawings making apparent to those skilled in the art how the several forms of the disclosed subject matter may be embodied in practice.

In the drawings:

FIG. 1A schematically illustrates a multi-section coil for a wireless power transmitter, in accordance with some exemplary embodiments of the disclosed subject matter;

FIG. 1B schematically illustrates an array of multi-section coils, of FIG. 1, in accordance with some exemplary embodiments of the disclosed subject matter;

FIG. 2 shows a block diagram of a wireless power transmitter adapted to independently and simultaneously activate each multi-section coil in the array, in accordance with some exemplary embodiments of the disclosed subject matter;

FIG. 3 shows a principle schematic of a frontend driver for the multi-section coil, in accordance with some exemplary embodiments of the disclosed subject matter;

FIG. 4 schematically illustrates a charging area situated above the array of multi-section coils, in accordance with some exemplary embodiments of the disclosed subject matter; and

FIG. 5 shows a flowchart of a method for shaping a magnetic energy pattern, in accordance with some exemplary embodiments of the disclosed subject matter.

### DETAILED DESCRIPTION

Before explaining at least one embodiment of the disclosed subject matter in detail, it is to be understood that the disclosed subject matter is not limited in its application to the details of construction and the arrangement of the components set forth in the following description or illustrated in the drawings. The disclosed subject matter is capable of other embodiments or of being practiced or carried out in various ways. Also, it is to be understood that the phraseology and terminology employed herein is for the purpose of description and should not be regarded as limiting. The drawings are generally not to scale. For clarity, non-essential elements were omitted from some of the drawings.

The terms “comprises”, “comprising”, “includes”, “including”, and “having” together with their conjugates mean “including but not limited to”. The term “consisting of” has the same meaning as “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this disclosed subject matter may be presented in a range format. It should be understood that the description in range format is merely for convenience and brevity and should not be construed as an inflexible limitation on the scope of the disclosed subject matter. Accordingly, the description of a range should be considered to have specifically disclosed all the possible sub-ranges as well as individual numerical values within that range.

It is appreciated that certain features of the disclosed subject matter, which are, for clarity, described in the context of separate embodiments, may also be provided in combination in a single embodiment. Conversely, various features of the disclosed subject matter, which are, for brevity, described in the context of a single embodiment, may also be provided separately or in any suitable sub-combination or as suitable in any other described embodiment of the disclosed subject matter. Certain features described in the context of various embodiments are not to be considered essential features of those embodiments, unless the embodiment is inoperative without those elements.

One technical problem dealt with by the disclosed subject matter is lack of uniformity of the magnetic field across a transmitter (Tx) coil, in general, and across an array of transmitter (Tx) coils in particular. Tx coils have a concentric magnetic field pattern having its maximum magnetic field energy at the center that is declined towards the coil's outer circumference. Such behavior of commercially available Tx coils creates a fixed magnetic field pattern which is not effective and cannot support receivers of all device sizes, such as watches (small), smartphones (medium), laptops (large), and any combination thereof, or the like. By using these standard transmitter coils, only the magnitude of the magnetic field can be controlled, but not its shape.

Another technical problem dealt with by the disclosed subject matter is caused due to installing the transmitter beneath a surface on which the device is placed for charging. Distancing the transmitter coil vertically by more than a few millimeters from the device and the medium between them, causes the magnetic field pattern to be spread away and have a lower decay slope as the distance of the receiver away from the Tx coil center is increased. Consequently, the magnetic field energy expands outside the desired area of the receiving coil and in the area that may be coupled to foreign objects.

One technical solution is providing a coil having wires that are not evenly distanced. In some exemplary embodiments, the wire spreading pattern can be formed in a way that modifies the shape of the magnetic field pattern, and to concentrate it in the desired radius.

Another technical solution is structuring the coil in such a way that some of the wire loops are arranged in opposite direction to other wire loops of the coil. In some exemplary embodiments, such structuring creates scenarios where current on some of the loops flows in an opposite direction with respect to other loops, subsequently reducing or cancelling magnetic field at specific radius.

In yet another technical solution, the two listed above solutions, can be combined for providing a way to shape the magnetic field to a specific fixed pattern.

Yet another technical solution is to split the Tx coil into sections that are connected to different power drivers. In some exemplary embodiments, the Tx coil sections can be connected to single power driver in parallel; however, each section comprises different capacitor, resulting in different current levels for each section. Also, the currents may even be inverted in polarity.

In some exemplary embodiments, the current driving pattern (for any combination of the above solutions) to the different sections may vary dynamically, such that the overall resulting magnetic field pattern is modified to have different effective radiuses. The pattern can be selected for fitting specific receiver needs, e.g. geometry, power needs, location and any combination thereof, or the like. Additionally, or alternatively, the receiver of the device sends the transmitter information that can be used for estimating the size of the receiver coil. Subsequently, a controller of the transmitter modifies the current pattern to the different coil sections to produce the best matching magnetic field pattern that fits the receiver coil geometry.

In some exemplary embodiments, the transmitter estimates a coupling factor with the receiver or any object placed on a top surface; such as ferrite protection ring, a coin, or the like; by driving its power drivers and observing the current or current decay pattern. Accordingly, the transmitter utilizes the derived coupling factor to shape the magnetic field pattern by controlling the current pattern to the sections of the coil.

In yet another technical solution, different capacitors can be connected to each section of the Tx coil so that the resonance frequencies of each section are different. This approach eliminates the need for power driver for each coil section. In some exemplary embodiments, the controller of the transmitter, modifies the power driver toggling frequency to modify the current pattern for each coil section. Thereby, increasing/decreasing the current to specific section is performed for shaping the magnetic field pattern.

In yet another technical solution, the magnetic field pattern of a specific coil can be shaped to match a specific desired magnetic field pattern. In some exemplary embodiments, a method for shaping specific magnetic field pattern of a given coil comprises calculation based on Maxwell equations.

One technical effect of utilizing the disclosed subject matter is providing a system and method for optimizing the magnetic pattern of one or more transmitter coils above which the receiver is placed. It should be reminded that commercially available arrays of transmitter coils are limited for activating the nearest Tx-coil/coils to the receiver. In contrast, the multi-section coils system and methods of the present disclosure shape the magnetic pattern to fit the position of the receiver for best coupling and power efficiency. In some exemplary embodiments, the shaping is done by selectively activating relevant sections of the participating coils, while non relevant coils/sections are off.

Another technical effect of utilizing the disclosed subject matter is confining the transmitter's magnetic pattern to a circular area on the center with diameter that matches the size of the receiving coil, and sharply falling outside this area. Thereby, minimizing effects of magnetic field coupling to foreign objects, i.e. device's housing, and to other metal objects that may be placed beside the intended receiver.

Yet another technical effect of utilizing the disclosed subject matter is providing improved magnetic field pattern that may also be dynamically modified to fit the receiving device, and/or installed under different surfaces of varying thicknesses.

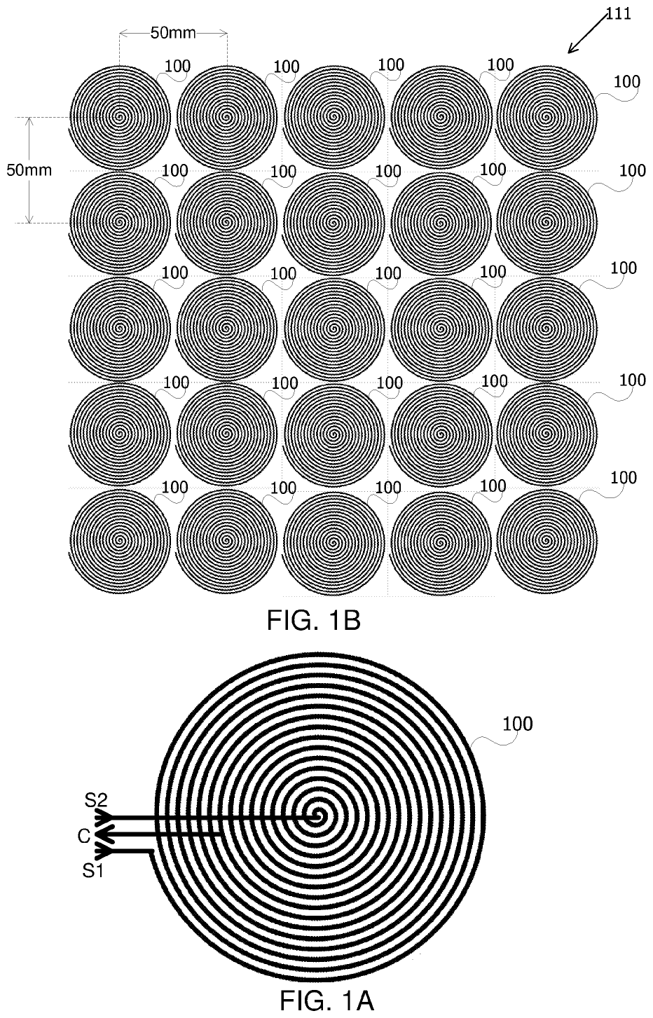

Referring now to FIG. 1A schematically illustrating a multi-section coil for wireless power transmitter, in accordance with some exemplary embodiments of the disclosed subject matter. Coil 100 is divided into two concentric sections (first and second) that are connected in series and provided with leads on each end as well as a central tap to the connection between the coils. However, it should be noted that coil 100 as described above and as depicted in the FIG. 1A is only one possible useful embodiment selected in this description primarily for the sake of simplifying the description. The system and methods described hereinafter, are configured to support coil 100 that can comprise any number of sections, from 1 to N. Additionally, or alternatively, coil 100 of the present disclosure can have concentric shape, a non-concentric shape, any two dimensional shape and any combination thereof, or the like. Furthermore, the sections of coil 100 can be equal on non-equal, in size, to one another, i.e. non-uniform wire distribution coils.

Referring now to FIG. 1B schematically illustrating an array of the multi-section coils, in accordance with some exemplary embodiments of the disclosed subject matter. Array 111 is an array of 5×5 coils 100 arranged in a rectangular formation with a specific size of 50 millimeters on the X and Y direction between the coils, i.e. total array size of 250×250 millimeters. However, it should be noted that array 111, as described above and as depicted in FIG. 1B, is only one possible useful embodiment selected in this description primarily for the sake of simplifying the description. The system and methods described hereinafter, are configured to support array 111 that can comprise any number of coils 100, that are not necessarily situated in a rectangular formation, e.g. hexagon, pentagon, circle, or the like. Additionally, or alternatively, coils 100 comprised in the array can be a mixture of any type and size of the coils 100 as described above.

In some exemplary embodiments, the array 111 can be installed about 30 millimeters below a charging-area on which the receiver can be placed. In some exemplary embodiments, the magnetic field contribution (Cont) of each section, i.e. total of 50 sections, can be calculated for a matrix of 30×30, but not limited to, different charging locations that are spaced 20 millimeters (on the X and Y directions), from one another. Thereby, yielding a total of 900 charging locations spreading over an area of 600×600 millimeters.

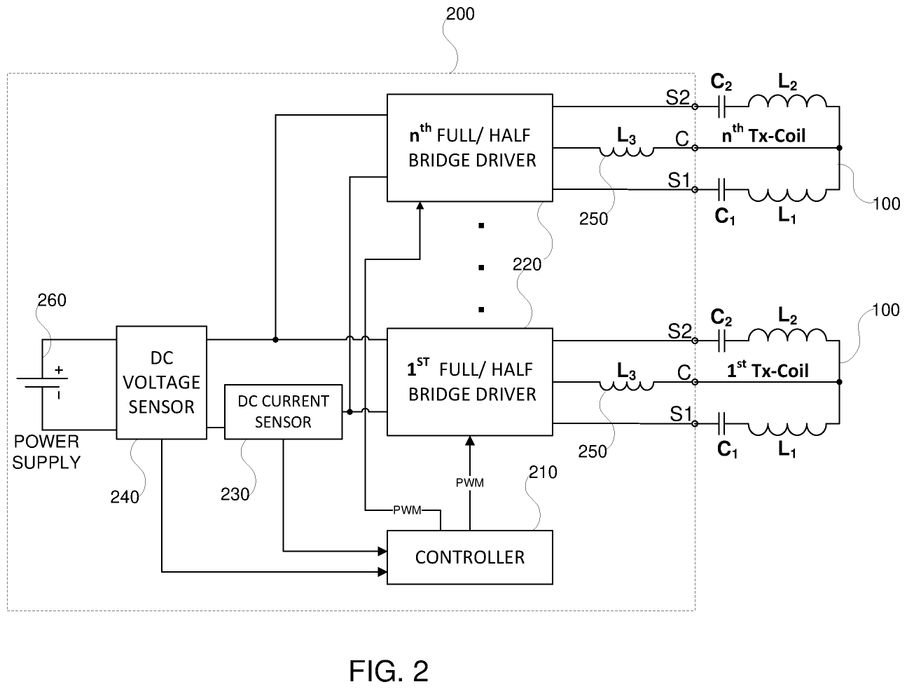

Referring now to FIG. 2 showing a block diagram of a wireless power transmitter adapted to independently and simultaneously activate each multi-section coil in array, in accordance with some exemplary embodiments of the disclosed subject matter. Transmitter (Tx) 200 comprises a power-supply 260, a DC voltage sensor 240; DC current sensor 230; a controller 210; at least one full/half bridge driver (driver) 220 coupled with a coil (L3) 250.

In some exemplary embodiments, the Tx 200 is utilized for charging a user's chargeable device (not shown), placed on the charging-area situated above array 111 (not shown in this figure), by one or more coils 100 that form the array 111. Each coil 100 comprises at least one section having one inductor and one capacitor that form an LC resonance circuit. In some exemplary embodiments of the disclosed subject matter, coil 100 comprises two inductors, L1 and L2 and two capacitors C1 and C2. L1 and C1 form a first section LC resonance circuit, connected via S1 to bridge 220, and L2 and C2 form a second section LC resonance circuit connected via S1 to bridge 220. At the other end, both sections are connected together via terminal C to bridge 220.

In some exemplary embodiments, each coil 100 of array 111 is connected to a dedicated driver 220, i.e. a first driver 220 supports a 1^{st} coil 100 in the array 111, and an n^{th} driver 220 supports an n^{th} coil 100 in the array 111.

In some exemplary embodiments, controller 210 can be a central processing unit (CPU), a microprocessor, an electronic circuit, an integrated circuit (IC), or the like. Additionally, or alternatively, controller 210 can be implemented as firmware written for or ported to a specific processor such as digital signal processor (DSP) or microcontrollers, or can be implemented as hardware or configurable hardware such as field programmable gate array (FPGA) or application specific integrated circuit (ASIC). In some exemplary embodiments, controller 210 can be utilized to perform computations required by Tx 200 or any of its subcomponents.

In some exemplary embodiments of the disclosed subject matter, the controller 210 can be configured to utilize sensors 240 and 230 for determining DC voltage across PS 260 by acquiring and measuring an outcome of DC voltage sensor 240. Additionally, or alternatively, controller 210 is configured to determine AC current supplied to each section of each coil, by sensing instantaneous current flowing to the driver from the power supply with DC current sensor 230.

It should be noted that the controller 210 has the capability of regulating the current pattern to each different coil sections, via its dedicated driver, for producing best matching magnetic field pattern that fits the device's receiver coil geometry. The current pattern regulation can be based on determining necessary parameters, such as peak current, average of absolute current, RMS current, amplitude of first harmonic, polarity, and any combination thereof, or the like.

In some exemplary embodiments, controller 210 comprises a semiconductor memory component (not shown). The memory can be persistent or volatile memory, such as for example, a flash memory, a random-access memory (RAM), a programmable read only memory (PROM), a re-programmable memory (FLASH), and any combination thereof, or the like.

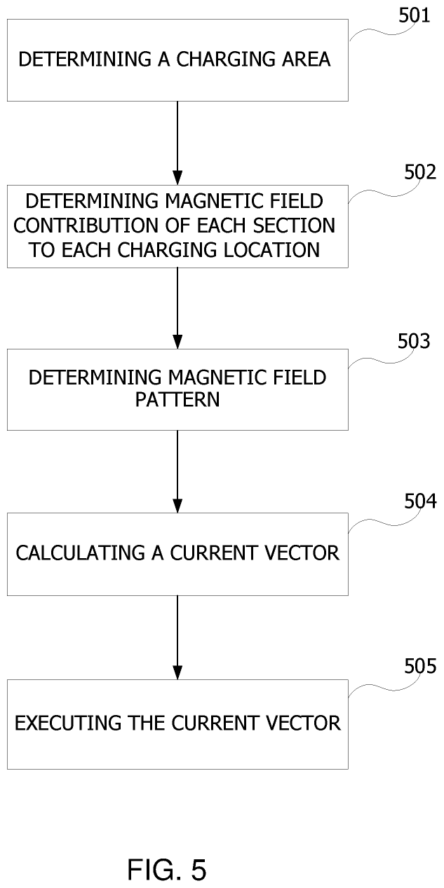

In some exemplary embodiments, the memory can be configured to retain program code to activate controller 210 to perform acts associated with determining a pulse width modulation (PWM) signal that controls the full or half bridge driver 220. Additionally, or alternatively, the memory of controller 210 retains instructions and code adapted to cause the controller 210 to execute steps of the method depicted in FIG. 5.

In some exemplary embodiments, Tx 200 comprises one or more drivers 220, each driver configured to drive AC current to a coil 100 to which it is dedicated. Each driver 220 can adjust the output current flowing through S2 and S1, i.e. power provided by the Tx 200, by modulating an operating frequency and/or duty cycle of the current flowing through the sections of any one of coils 100 of the array 111. In some exemplary embodiments, the PWM signal generated in the controller 210 tunes the modulation to satisfy the magnetic field contribution (Cont) of each section of each coil in the array as determined in the method depicted herein after in FIG. 5.

In some exemplary embodiments, the controller 210 uses its memory to retain, connectivity software, monitoring information, configuration and control information and application associated with charging management of the present disclosure.

In some exemplary embodiments, the controller 210 configures to communicate with the chargeable device (not shown) based on protocols that comply with communication standards, such as power matters alliance (PMA); wireless power consortium (WPC) and AirFuel Alliance. According to these communication methods, but not limited to, the controller 210 can be configured to acquire user's credentials from the device in order to authenticate users for granting and regulating charging services. Additionally, or alternatively, the controller 210 can be also configured to acquire power requirements from device 20.

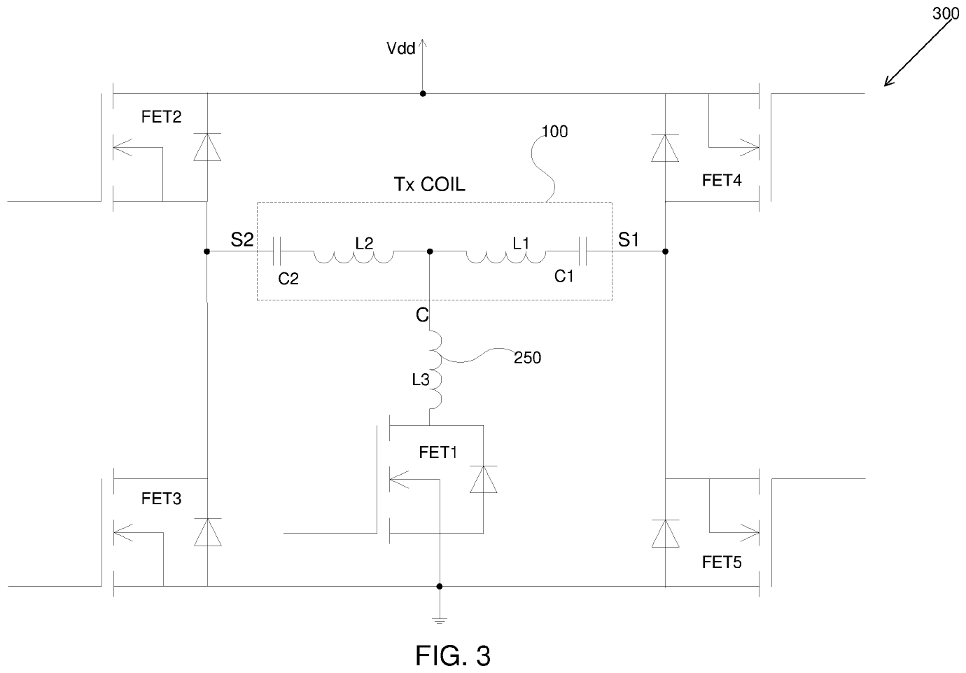

Referring now to FIG. 3 showing a principle schematic of frontend drivers of the multi-section coil, in accordance with some exemplary embodiments of the disclosed subject matter. Frontend drivers 300 are an electronic circuit incorporated in each full/half bridge driver 220 of the Tx 200 of the present disclosure.

In some exemplary embodiments, driver 220 can be configured to be operated in either half bridge mode or full bridge mode. In full bridge mode, both 1^{st} and 2^{nd} sections (L1,C1 and L2,C2 respectively) operate together as one coil (coil 100) facing the same current. In half bridge mode, FET2 and FET3 drive the 2^{nd} section and FET4 and FET 5 drive the 1^{st} section, while FET1 is on, i.e. ground potential. It should be noted that both sections can be driven simultaneously by different or same current by their respective FETs.

Additionally, or alternatively, one section can be driven by a different frequency than the other, for regulating the magnetic field generated by the one section at certain distance.

In some exemplary embodiments of the full mode, capacitors C1 & C2, connected on each side of coil 100, are tuned to have inverse reactance to the coil section they are connected to (L1 & L2 respectively) at a designated resonance frequency of Tx 200. Such capacitors tuning is done to cancel out the impedance of the sections at an operation frequency in order to allow high current flow.

For the sake of the half mode, independent section operation, the central tap [C] is connected via L3 to FET1, that closes the section circuit (ground), when active, while FET2 & FET3 are toggling the power from Vdd at a designated operation frequency. In some exemplary embodiments, the inductor L3 value is selected to have a zero (0) equivalent impedance, together with an active section, either L1&C1 or L2&C2 at the designated operation frequency. It should be noted that Tx 200 can have at least one designated frequency for full mode and at least one designated frequency for each section at half mode.

It will be understood that the inductance of any section is significantly lower, while the other section is off, than its inductance when the other section is on due to the coupling between the two sections. In some exemplary embodiments, inductor L3 enables tuning the resonance frequency when operating with one of the sections and compensate for the inductance loss vs. the operation of the section when the other section is active.

In some exemplary embodiments of half mode, FET1 is set active, the FETs of one section are set to tristate (i.e. disconnected) and the FETs of the other section is set to toggle Vdd to the coil, thus activating one section at half mode. Additionally, or alternatively, FET1 is set active, and the FETs of both sections are set to toggle Vdd to the coil, thus activating both sections at half mode. It should be noted that in any case of half mode, each coil of each section (L1 & L2) operates with its serial capacitor (C1 & C2 respectively) and inductor L3.

In some exemplary embodiments of full mode, FET1 is off and FET2 & FET 3 are inverse of each other and toggling the 2nd section. Similarly, FET4 & FET5 are inverse of each other and toggling the 1st section.

In some exemplary embodiments of the disclosed subject matter, each section of the coil 100 can provide different magnetic field pattern to match different applications or installation conditions. One of the sections or combination of the two sections can create a coil that matches specification of one of the existing standard coils as defined in relevant specifications.

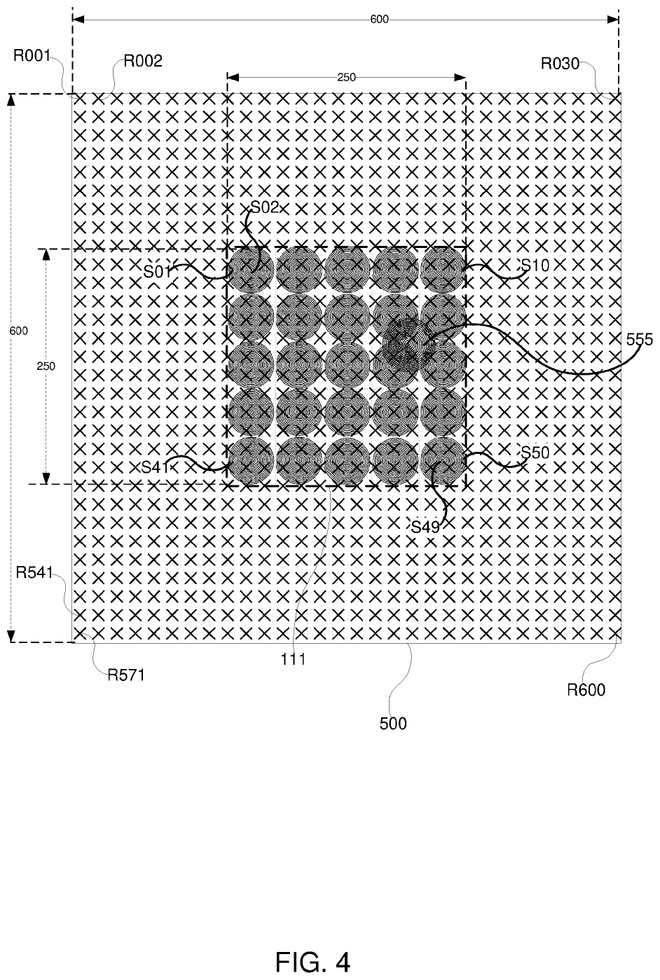

Referring now to FIG. 4 schematically illustrating a charging area situated above the array of multi-section coils, in accordance with some exemplary embodiments of the disclosed subject matter. A charging area 500 marks a center of charging locations on which a chargeable device (receiver) may be placed.

For the sake of simplifying the explanation of the calculations according to the method described hereinafter (in FIG. 5), the following example is provided. However, it will be emphasized that the coils 100 incorporated in the array 111 are not limited to two sections. Also, array 111 arrangements can be expanded to comprise coils 100 that are non-concentric; coils 100 that are concentric; coils 100 that have different centers; and any combination thereof, or the like.

In some exemplary embodiments, array 111 comprises fifty coils 100 arranged in a rectangular formation having a total array size of 250×250 millimeters. In this example, each coil 100 is divided to two concentric sections, thus 50 sections altogether. Labels S01, S02, S10, S41, S50 mark some sections position in the array; e.g. S01 marks the first section of the array, S02 marks the second section and so on to the last section marked S50. It should be noted that in the present disclosure, a section in an array is designated by [N] thus, the total N sections in this example equal to 50.

In some exemplary embodiments, the magnetic field contribution (Cont) of the section, can be determined by calculating a current vector for each charging location of charging area 500. In this example, the charging area is a matrix of 30×30 different charging locations that are spaced 20 millimeters from one another. Thereby, a total of 900 charging locations spreading over an area of 600×600 millimeters.

Labels R001, R002, R030, R541, R571, and R600 mark some charging locations position in the charging area 500; e.g. R001 marks the first location in area 500, R002 marks the second locations and so on to the last locations marked R600. It should be noted that in the present disclosure, a charging location position in a charging area is designated by [M] thus, the total M locations in this example equal 600.

One of the objectives of this disclosed subject matter is to derive a square matrix UCont (a 50×50 square matrix in this example) and magnetic field pattern vector UP (having a size of 50 in this example), followed by determining a current vector for each one of the sections. In some exemplary embodiments, a preferred magnetic field pattern (vector UP) is determined for covering placement of a receiver 555 on the different locations on the charging area 500 followed by different current vectors for each location area 500. In some exemplary embodiments, the determination can be performed by controller 210, as shown in FIG. 2, in real time based on the location of receiver 555 on area 500. Additionally, or alternatively, the determination can be precomputed to include different current vectors per receiver location that are stored in the Tx 200 nonvolatile memory in order to save time and computational power in the transmitter.

In some exemplary embodiments, contribution (Cont) of each section 1 through N to the magnetic field pattern at locations 1 through M can be expressed by a matrix, Cont of N*M values. The Cont of a specific section can be mathematically calculated based on Maxwell equations, possible for simple symmetric topologies without surrounding ferromagnetic, using a standard simulation tools for Maxwell equations solution. Additionally, or alternatively, the contribution of a specific section can be obtained by measuring the magnetic field created by a reference current, e.g. 1A flowing only through the specific section, for all the locations 1 to M.

A multiplication of the matrix by an N element vector I, which represents the current flowing in each section, would produce the magnetic field pattern P for each M point, thus Cont×I=P.

It is noted that in the case of N=M, a standard matrix algebra can be used to compute the inverse matrix of Cont and then the desired currents: I=Cont⁻¹*P. However, such solution may produce a nonstable solution that requires very high alternating phased currents on the sections. Although this can produce desired pattern on the specific locations in the area, this can cause very high magnetic fields in between them.

In some exemplary embodiments of the disclosed subject matter, an approach based on M>N, for providing a desired pattern, followed by optimizing a mean square error of the magnetic field pattern with respect to a desired pattern.

### Thus,

$$Error = {\sum }_{m = 1}^{M} {( ( {\sum }_{n = 1}^{N} Cont ( m , n ) * I ( n ) ) - P ( m ) )}^{2}$$

Derivation of the Error term above for every current I(n) would lead to the following equation:

$$UCont ( a , b ) = {\sum }_{n = 1}^{M} Cont ( n , a ) * Cont ( n , b )$$

Were UCont is an N×M matrix

$$UP ( a ) = {\sum }_{n = 1}^{M} Cont ( n , a ) * P ( n )$$

UP is an N element vector, so the solution in this case is: I=UCont⁻¹*UP

In some exemplary embodiments, P can be typically field strength (either B or H field) measured in Gauss units. It should be noted that UP is not P, UP is mathematical expression used as in a calculation. Cont has similar units of P divided by current, measured in Amperes (A), i.e. if P has Gauss units, then Cont will have Gauss/A units.

The above equation for calculating UCont provides stable magnetic field pattern, yet it does not take into account current increase in the sections. In some exemplary embodiments, the equation above can be modified to overcome the current increase in the sections by calculating the UCont matrix as follows:

$$UCont ( a , b ) = {\sum }_{n = 1}^{M} Cont ( n , a ) * Cont ( n , b ) + C * δ ( a - b )$$

In some exemplary embodiments, δ(x) is a standard delta function being 1 for a−b=0 and 0 for all other a-b values. Where a & b are enumerators of the elements of the matrix UCont going from 1 to N. The constant C is the current weight function. The larger the number, the lower the currents on the wires will be on the expense of larger deviation of magnetic field pattern from the desired pattern.

The derived current vector I can be used to define current values for sections of a coil, or to be converted to wire density of the sections, function allowing design of non-uniform wire distribution coils. As an example, if I(1)=3 Amperes (A) relating to a first section of coil 100 and I(2)=2A relating to a second section of the coil, where magnetic field patterns were calculated with density of 1 wire/mm, than each section uses the same wire density of 1 wire/mm and drive 3A through section 1 and 2A through section 2. Alternatively, a fixed 1A current through both sections can be used, however the wire density at the 1^{st} section should be 3 wire/mm and 2 wire/mm on the 2^{nd} section.

Negative currents can be implemented in this case simply by running the wire loop on a reverse direction (counter clockwise vs. clockwise). In order to overcome the constrain of centering the magnetic field, the above concept can be expanded to coil arrangements that are non-concentric.

It should be noted that the contribution of each of these sections to magnetic field on different locations M is calculated to derive the matrix Cont as described above, the target magnetic field pattern vector P will refer in this case to locations in a 2D plane, the rest of the calculations are as described above for the concentric case.

Referring now to FIG. 5 showing a flowchart of a method for shaping a magnetic field pattern, in accordance with some exemplary embodiments of the disclosed subject matter.

In step 501, a charging area 500 is determined. In some exemplary embodiments, charging area 500 comprises a plurality of charging locations that has a total of M charging locations, which is situated above array 111 that comprises a plurality of sections having a total of N sections. In some exemplary embodiments, an area of charging area 500 is larger than an area of array 111. For example, FIG. 4 illustrates a rectangular shaped charging area 500 that comprise 30×30 different charging locations that are spaced 20 millimeters from one another. Therefore, a total of 900 (M=900) charging locations having a total size of 600×600 millimeters. The array 111, in this example, comprises 25, two sections, coils 100 having a size of 50×50 millimeters each. Thereby, a total of 50 (N=50) sections having a total array 111 size of 250×250 millimeters, which is smaller than the size of the charging area 500.

It will be noted that the charging locations are spaced more densely than the coil density and extend beyond coil coverage area.

In step 502, a magnetic field contribution (Cont) of each section to each charging location is determined. The Cont of each section 1 through N to the magnetic field at locations 1 through M is expressed by a matrix, Cont of N*M values (measured in Gauss/Ampere), upon completion of step 502. In some exemplary embodiments, the Cont of a specific section is mathematically calculated based on Maxwell equations, using standard simulation tools for Maxwell equations solution. Additionally, or alternatively, the contribution of a specific section can be obtained by measuring the magnetic field created by a reference current, e.g. 1A flowing only through the specific section, for all the locations 1 to M and repeatedly for each section.

It should be reminded that the sections, 1 through N of the array 111 can be a mix of sections having different properties, such as specific topology, wire density, and a combination thereof, or the like, therefore the Cont of each section to any specific charging location depends on its properties and its distance from the specific charging location.

In step 503, a magnetic field pattern P is determined. In some exemplary embodiments, the magnetic field pattern P is a vector comprised of magnetic field values (measured in Gauss) for each charging location 1 through M of the charging area 500. The magnetic field pattern P, also known in this present disclosure as P-vector is determined for each charging location by utilizing the equations hereinbefore. Accordingly, P-vector manifests a magnetic field pattern of area 500 at any given time.

It will be understood that P-vector is determined to provide an optimal magnetic field pattern to one or more receivers, such as receiver coil 555 of FIG. 4, placed on area 500. It will also be understood that the determination of P-vector dynamically changes, i.e. repeatedly executing the determination of P-vector, due to movement of a receiver; placing another receiver; removing any receiver; and any combination thereof, or the like.

In the example of FIG. 4, all the charging locations (marked by X) that are situated beneath receiver coil 555 should be more influential charging locations, which means that magnetic field in those charging locations has to be more powerful, while the magnetic field of the rest of the charging location should be zero. Thus, the determination of P-vector dynamically changes with respect to the momentary position of receivers as well as the number of receivers placed on the charging area 500. Therefore, P-vector, or in another words, the magnetic field pattern of charging area 500 represents the required magnetic field pattern of area 500 at any given time.

Additionally, or alternatively, P-vector can be determined for arbitrary charging location.

In some exemplary embodiments, charging locations that are situated beneath a receiver, such as coil 555, can be defined as a specific place of a receiver that is situated on charging area 500. The specific place of the receiver coil can be determined by Tx 200 separately activating each coil 100 in the array with a single power pulse and obtaining, from the device of the receiver, a received power value. Upon activating all the coils in the array and receiving all the power values from the device, the Tx 200 can determine all the charging locations associated with the receiver coil specific location, based on the relative power value measured by the device.

In most practical cases, the pattern vector has high values in charging locations that are directly beneath the receiver and close to zero values in areas that are outside the receiver projection. In other examples, charging location of charging area 500 that are not accessible may be omitted from calculation. In yet other example, the charging area 500 can support more than one receiver resulting with one pattern vector that includes more than one separate area high values.

It will be understood that a pattern for a receiver (such as depicted in FIG. 4) theoretically includes high field below the receiver and zero field outside the receiver's projection. However, the mathematical solution may calculate current vector that includes activating sections that are outside the coverage area of the receiver. This is due to their contribution to the overall field, which may work to reduce the overall error term representing the difference between actual field pattern to the desired field pattern as expressed by vector P.

In step 504, a current vector is calculated for each pattern vector that was determined in step 503. In some exemplary embodiments, the Tx 200 calculates a specific current vector, comprised of current values for all the sections, for any specific vector P that represents a magnetic field pattern required by one or more receivers, such as receiver 555, as previously described. Thus, the current vector [I] defines current values for each section for satisfying a necessary pattern [P] shape of the charging area 500, which can have one or more designated charging locations.

In some exemplary embodiments, a single current (i.e. single driver) can be used to drive coil 100 having a non-uniform wire density in a predetermined direction and/or reverse direction. It will be reminded that in previously described exemplary embodiment, such coils are designed to yield fixed predefined magnetic field pattern. It should also be noted that array 111 comprises a mix of coils, some of which are uniform and concentric while one or more can be non-uniform. In some exemplary embodiments, a location of the non-uniform coils can be marked on the charging area to indicate to a user the location of such coils. In some exemplary embodiments, the non-uniform coils that form fixed predefined magnetic field pattern are provided for specific receivers; such as for example, large receivers coil (for a laptop); very small coils (for a device such as a watch); or the like. It should be noted that, current vector I can combine current values for sections and fixed current for non-linear coils.

In step 505, a current vector is executed. In some exemplary embodiments, the Tx 200 uses at least one driver 220 to execute the calculated current vector. The current vector can be dynamically altered upon: removing the receiver from Area 555, moving the receiver on Area 555, placing additional receiver on Area 555; and any combination thereof, or the like.

Additionally, or alternatively, the Tx 200 can execute a precalculated current vector designated to shape magnetic field patterns of at least one preset charging location on the charging area 500. Wherein, the at least one preset charging location is labeled on the charging area 500

Additionally, or alternatively, the transmitter is configured to drive each section of the at least one coil independently.

In some exemplary embodiments of the disclosed subject matter, the method described in FIG. 5 excluding step 505 can be used for designing one or more coils, such as coil 100 that comprises one or more sections. The design comprises customizing/adjusting geometrical properties, primarily coil density, of one coil or a plurality of coils that can form an array of coils, such as array 111 shown in FIG. 1B, and their sections.

In some exemplary embodiments, the geometrical properties of each such coil comprises adding/subtracting sections and/or making geometrical adjustments to uniform wire density coils; non-uniform wire density coils; concentric coils; non-concentric coils; reverse direction coils; and any combination thereof, or the like.

The embodiment described above for designing one or more coils is based on the calculated current vector of step 504, which constitutes the criteria for designing the geometrical properties of any coil and its sections. In other words, a design outcome of the one or more coils, expressed in the geometric properties, compensates, i.e. satisfies, for the current vector that was calculated for shaping a specific magnetic field pattern. Thereby, the coils design outcome enables driving all the involving coils (one or more) and their sections only with one current driver of the Tx200.

In some exemplary embodiments, using one or more coils having wires that are not spaced evenly cause spreading pattern to modify the shape of the magnetic radiation pattern, and to concentrate it in the desired radius. Additionally, or alternatively, one or more coils can also be structured such that some of the wire loops are arranged in an opposite direction to other wire loops of the coil; this would create a scenario were current flowing in the coil would have clockwise direction on some of the loops and counter clockwise for others. The effect of such arrangement would be to reduce or cancel the magnetic field at specific radius.

The present disclosed subject matter may be a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

1. A method for wirelessly charging, by a transmitter, at least one receiver placed above at least one coil having at least one section, the method comprising:
determining a plurality of charging locations that form a charging area above the at least one coil;
determining a matrix of magnetic field contributions of each section in the at least one coil to each charging location of the plurality of charging locations; determining a magnetic field pattern of the charging area;
calculating a current vector that comprises a current value for said each section in the at least one coil; and
driving, by the transmitter, said each section in the at least one coil with the current vector for shaping the magnetic field pattern.

2. The method of claim 1, wherein said at least one coil is an array of coils, and wherein each coil is comprised of at least one section.

3. The method of claim 2, wherein a total number of the charging location in the charging area is greater than a total number of sections in the array.

4. The method of claim 2, wherein the matrix of magnetic field contributions is determined based on mathematical calculations using simulation tools for Maxwell equations solution.

5. The method of claim 2, wherein the matrix of magnetic field contributions is determined based on measuring a magnetic contribution of each charging location of the plurality of charging location that is created by a predetermined reference current flowing in turn through each section, wherein the measuring is repeated for each turn.

6. The method of claim 2, the method comprising storing the matrix of magnetic field contributions in a memory of the transmitter.

7. The method of claim 2, wherein the magnetic field pattern provides an optimal magnetic field values to the at least one receiver placed on the charging area.

8. The method of claim 2, wherein said determining a magnetic field pattern of the charging area is repeatedly executed to dynamically update the magnetic field pattern due to changes selected from a group consisting of a movement of a receiver on the charging area; placing another receiver on the charging area; removing any receiver from the charging area; and any combination thereof.

9. The method of claim 2, wherein the transmitter is configured to determine a specific place of the at least one receiver placed on the charging area, and wherein the specific place define at least one charging location associated with the specific place.

10. The method of claim 9, wherein the magnetic field pattern of the charging area has powerful magnetic field at charging location associated with the specific place and close to zero magnetic field at the rest of the charging location.

11. The method of claim 8, wherein the current vector is configured to shape the magnetic field pattern of the charging area and wherein said calculating a current vector is repeated following changes of the magnetic field pattern.

12. The method of claim 2, wherein said calculating a current vector that comprises a current value for said each section further comprises providing a magnetic field pattern with minimal error.

13. The method of claim 9, wherein the current vector comprises current values greater than zero for sections associated with charging location that are not associated with the specific place for reducing magnetic field pattern errors.

14. The method of claim 1, wherein the transmitter is configured to drive the at least one coil having at least one section independently.

15. The method of claim 1, wherein the transmitter is configured to drive each section of the at least one coil independently.

16. A method for designing at least one coil having at least one section, the method comprising:
determining a plurality of charging locations that form a charging area above the at least one coil;
determining a matrix of magnetic field contributions of each section in the at least one coil to each charging location of the plurality of charging locations;
determining a magnetic field pattern of the charging area;
calculating a current vector that comprises a current value for said each section in the at least one coil; and
designing geometrical properties of said at least one coil having at least one section according to the current vector.

17. The method of claim 16, wherein the geometrical properties of said at least one coil having at least one section are selected from a group consisting of: uniform wire density coils; non-uniform wire density coils; concentric coils; non-concentric coils; reverse direction coils; and any combination thereof.

18. The method of claim 16, wherein an outcome of said designing geometrical properties of said at least one coil having at least one section is configured to satisfy the current vector to enable driving said at least one coil having at least one, by a single driver of a transmitter, with only one current for shaping the magnetic field pattern.
